(19) United States
(12) Patent Application Publication
(10) Pub. No.: US 2005/0015209 A1
(43) Pub. Date: Jan. 20, 2005

(54) Eddy current testing apparatus with integrated position sensor

(76) Inventor: Stefan Wuebker, Wiefelstede (DE)

Correspondence Address: FASSE PATENT ATTORNEYS, P.A., P.O. BOX 726, HAMPDEN, ME, 04444-0726, US

(21) Appl. No.: 10/886,832

(22) Filed: Jul. 7, 2004

(30) Foreign Application Priority Data
Jul. 15, 2003 (DE) 103 31 953.0

(51) Int. Cl. G01B 5/28

(52) U.S. Cl. 702/38

(57) ABSTRACT

An apparatus for eddy current testing of a test specimen includes a movable testing unit and a separate evaluating unit. Incorporated therein, the movable testing unit includes an optical position sensor as well as a testing head that has an eddy current generator and an eddy current sensor. The testing head generates and measures an eddy current in the test specimen, while the optical position sensor optically senses the position of the testing head on the test specimen. The optical position sensor includes a camera unit and a signal processor that determines the displacement direction and distance of the testing head based on differences among successive images of the specimen surface sensed by the camera unit. The camera unit includes a light emitting diode and an optical detector such as a CMOS sensor. The evaluating unit evaluates the measured data and allocates it to the associated position data.

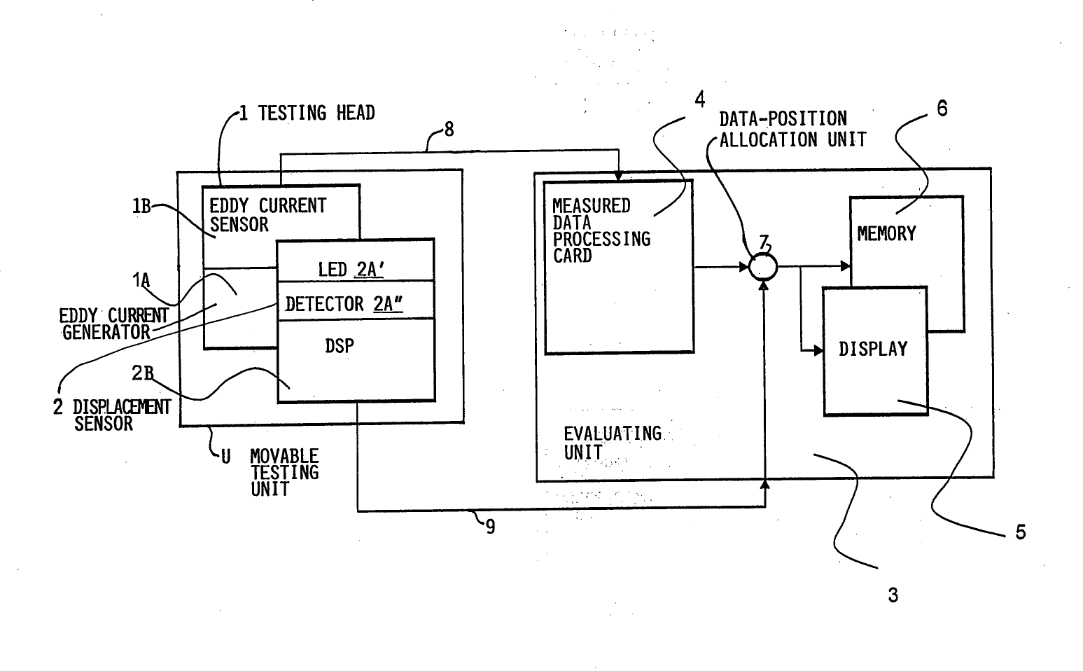

### PRIORITY CLAIM

This application is based on and claims the priority under 35 U.S.C. §119 of German Patent Application 103 31 953.0, filed on Jul. 15, 2003, the entire disclosure of which is incorporated herein by reference.

### FIELD OF THE INVENTION

The invention relates to a an eddy current testing apparatus comprising an eddy current testing head including an eddy current generator and an eddy current receiver or sensor, an arrangement for determining the position coordinates of the eddy current testing head, and an evaluating unit for correlating the measured data provided by the eddy current testing head with the respective associated position coordinates.

### BACKGROUND INFORMATION

It is known to test conductive materials and components (i.e. test specimens) by inducing an eddy current in the test specimen by a moving and/or varying magnetic field, and measuring the parameters of the actual eddy current that is induced relative to the parameters of the applied excitation. With such eddy current testing, for example, flaws, defects or damage such as cracks, pores, inclusions, grain structure defects, etc. can be detected, identified, and located in the test specimen being tested. In order to be able to locate the detected flaws in the test specimen, it is necessary to register the position coordinates of the eddy current testing head relative to the test specimen during the testing measurements, and then to allocate these coordinates to the respective measured data provided by the measurements carried out by the testing head.

For this purpose, namely for registering and allocating the position coordinates of the testing head to the properly associated measured data, conventional eddy current testing apparatuses typically mount or connect the testing head on a scanner apparatus, for example either 2-D X/Y-scanner or a polar coordinate scanner, which moves the testing head over the area to be scanned, while registering the position coordinates of the testing head at successive locations. The position coordinates are referenced to the position of the testing head on the test specimen. Then, the test results, i.e. the measured data relating to the tested eddy current in the test specimen, are stored together with the position coordinate information provided by the scanner. The stored measured data can then be evaluated and respectively combined with the associated position coordinates, for example at a later time, such as after the end of the testing or inspection run.

Such known apparatuses suffer the disadvantage that they have a rather cumbersome structure due to the mechanical scanner device. Thus, such conventional apparatuses are not easily utilized in environments or for testing test specimens that have a complex structure and/or are difficult to access. Furthermore, compound errors can arise in the position data, because the position of the testing head is determined relative to the scanner arrangement, and the position of the scanner arrangement must then be referenced to positions on the test specimen itself. There is no direct coupling of the position of the testing head to positions on the test specimen.

### SUMMARY OF THE INVENTION

In view of the above, it is an object of the invention to provide an apparatus for eddy current testing of a test specimen, wherein this apparatus has a compact and simple construction taking up a relatively small volume, so that the apparatus can be easily used in a broad variety of applications, and especially with test specimens or areas that are difficult to access. A further object of the invention is to provide a direct indication of the position of the eddy current testing head directly relative to the test specimen. The invention further aims to avoid or overcome the disadvantages of the prior art, and to achieve additional advantages, as apparent from the present specification. The attainment of these objects is, however, not a required limitation of the present invention.

The above objects have been achieved according to the invention in an eddy current testing apparatus for eddy current testing of a test specimen, wherein the apparatus comprises a movable testing unit and an evaluating unit. The movable testing unit includes a testing head and an optical position sensor that are both united or combined to form the movable unit. In other words, the testing head and the optical position sensor are both incorporated together in the movable testing unit. Thereby, the testing head and the optical position sensor move together in common with one another as components of the movable testing unit. In this manner, the position sensor is directly coupled with the position and motion of the eddy current testing head, so that the position sensor can directly detect and register the position, or especially the displacement, of the testing head as the entire movable testing unit moves relative to the test specimen.

Throughout this specification, the term “position” refers to an absolute position, for example in the manner of the position coordinates of a particular location on the surface of the test specimen, as well as a relative position, e.g. in the manner of a displacement distance and direction from a first location to a second location on the surface of the test specimen. Preferably, the position sensor is a relative position sensor, i.e. a displacement sensor that detects and provides position data representing the displacement of the movable testing unit or particularly the testing head as it moves along the surface of the test specimen.

In this regard, the construction and operating principle of the position sensor corresponds to the optical displacement sensors typically used in other devices and other contexts, for example in an optical computer mouse or an optical computer pen. Such an optical displacement sensor detects the displacement of the sensor relative to the surface on which it is moving, by evaluating successive images of the surface and thereby determining the displacement distance and displacement direction of the differences (or apparent movement) of surface features of the surface of the test specimen among successive images. For this purpose in the present inventive context, the surface features of the surface of the test specimen being sensed or imaged by the optical displacement sensor can be inherent surface features such as a surface grain, texture, or pattern of the test specimen, or may include a surface pattern purposely provided on the test specimen for facilitating the displacement sensing.

In any event, the use of conventionally known and available components from other fields or applications, such as from optical computer mice as mentioned above, reduces the effort and expense of the development and commercialization of the present inventive apparatus, as well as reducing the costs thereof, and also ensures a high compatibility, for example in a “plug and play” manner, with standard hardware and standard applications of computer systems. Furthermore, the compact construction of the present apparatus incorporating both the testing head and the optical position sensor in a unitary movable testing unit makes it possible to inspect test specimens at locations or in arrangements that are difficult to access, while still maintaining the position reference of the acquired inspection or measurement data.

In a preferred embodiment, the optical displacement sensor includes an optical camera unit that comprises a light emitting diode as well as an optical detector allocated to the light emitting diode. Particularly, this optical detector is constructed as a complementary metal-oxide semiconductor (CMOS) optical sensor that achieves a very high resolution. This enables a high accuracy of the position data associated with the measurement data, which in turn provides a high accuracy in the determination of the location and the size of various detected defects, flaws, damages or the like, relative to the position of a reference point.

### BRIEF DESCRIPTION OF THE DRAWING

In order that the invention may be clearly understood, it will now be described in connection with an example embodiment thereof, with reference to the single accompanying drawing FIGURE, which schematically shows a block circuit diagram of the basic structure of an eddy current testing apparatus according to the invention.

### DETAILED DESCRIPTION OF A PREFERRED EXAMPLE EMBODIMENT AND OF THE

### BEST MODE OF THE INVENTION

The inventive eddy current testing apparatus generally comprises a movable testing unit U and an evaluating unit 3. The movable testing unit U includes an eddy current testing head 1 as well as an optical displacement sensor 2 that are incorporated together in the unitary movable testing unit U. The eddy current testing head 1 incorporates an eddy current generator 1A and an eddy current receiver or sensor 1B that are combined or incorporated in the testing head 1. The optical displacement sensor 2 comprises a camera unit 2A and a digital signal processor (DSP) 2B. While the camera unit 2A is incorporated in the movable testing unit U with the testing head 1, the digital signal processor 2B may be incorporated in the movable testing unit U or arranged separate and external from the movable testing unit U.

The camera unit 2A includes a light source 2A′ such as a light emitting diode (LED) 2A′, and an optical detector 2A″ that is preferably embodied as CMOS sensor structure 2A″. By means of the LED 2A′ the camera unit 2A illuminates the surface of the test specimen along which the movable testing unit U is moved, while the optical detector 2A″ detects image data of successive images of this illuminated surface as the movable testing unit U moves along the surface. The image data are captured by the camera unit 2A at the rate of up to several thousand images or frames per second. This image data is received and processed by the digital signal processor 2B in order to determine differences of surface features among successive images, and to calculate, from these differences, the displacement direction and the displacement distance of the camera unit 2A as it is moved along the surface of the test specimen.

For example, in this regard, the digital signal processor 2B can output position data representing the X-direction displacement (or position) and Y-direction displacement (or position) of the camera unit 2A as it moves along the test specimen surface. Alternatively, the position data output by the digital signal processor 2B could represent a radial displacement distance as well as a displacement angle for the direction relative to a reference point. Since the camera unit 2A of the optical displacement sensor 2 is incorporated with the eddy current testing head 1 in the movable testing unit U, the position data determined by the optical displacement sensor 2 directly correspond to the positions of the testing head on the test specimen as well. In other words, the position data determined by the optical displacement sensor 2 are directly coupled to the actual position of the testing head 1 on the surface of the test specimen, with merely a small fixed offset between the testing head 1 and the optical displacement sensor 2 or particularly the camera unit 2A.

The preferred arrangement of the camera unit 2A as described above can achieve an optical resolution of up to, or even greater than, 800 dpi or 0.03 mm. Thus, the apparatus can achieve a corresponding high accuracy of the position determination.

The evaluating unit 3 is separate from the movable testing unit U, and may be embodied in a portable computer such as a laptop computer for example. The evaluating unit 3 includes a processor or electronics card 4 that is connected by a first data link 8 to the testing head 1 and particularly the eddy current sensor 1B, so as to receive the measured data provided by the eddy current sensor 1B. In this regard, the data transmission link 8 may comprise an electrical conductor wire, an optical conductor fiber or cable, or a wireless transmission link such as a radio transmission link or an infrared transmission link. The processor or electronics card 4 evaluates the measured data to develop corresponding data regarding the detected condition of the test specimen.

In a data-position allocation unit 7, this data regarding the measurement information is then combined with or allocated to the proper associated position data, such as the position coordinates, provided by the optical displacement sensor 2. For this purpose, the data-position allocation unit 7 is connected by a second data transmission link 9 to the optical displacement sensor 2, and particularly the digital signal processor 2B, so as to receive the position data. Just like the first data transmission link 8, the second data transmission link 9 may comprise an electrical conductor wire, an optical conductor fiber or cable, or a wireless transmission link. The data-position allocation unit 7 can carry out any conventionally known combination or allocation of the position data with the measured data, for example by forming successive data packets that each include the measured data and the position data as well as any required protocol information in a pre-defined sequence of data bits. Alternatively, the measured data and the position data can be allocated to each other in a data table structure or the like. It is simply necessary that the corresponding position data identifying a particular position at which particular measured data have been measured, is allocated to that particular measured data in some pre-defined manner.

The position data and the measured data may be further processed, for example to be color coded and displayed on a monitor or display screen 5, and/or to be stored in a memory unit 6 for later read-out and/or further processing.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

1. An eddy current testing apparatus for eddy current testing of a test specimen, said apparatus comprising:
a movable testing unit including incorporated therein a testing head and an optical position sensor, wherein said testing head includes incorporated therein an eddy current generator adapted to generate an eddy current in the test specimen and an eddy current sensor adapted to sense the eddy current in the test specimen and to provide corresponding measured data, and wherein said optical position sensor is adapted to sense a position of said movable unit relative to the test specimen and to provide corresponding position data; and
an evaluating unit that is connected by a first data transmission link to said eddy current sensor so as to receive said measured data, and is connected by a second data transmission link to said optical position sensor so as to receive said position data, and is adapted to correlate said measured data respectively with respective associated ones of said position data.

2. The eddy current testing apparatus according to claim 1, wherein said movable testing unit fixedly incorporates said testing head and said optical position sensor, and said testing head fixedly incorporates said eddy current generator and said eddy current sensor.

3. The eddy current testing apparatus according to claim 1, wherein said first and second data transmission links comprise electrical conductors.

4. The eddy current testing apparatus according to claim 1, wherein said optical position sensor is an optical displacement sensor adapted to sense a relative position based on a displacement of said movable testing unit relative to the test specimen.

5. The eddy current testing apparatus according to claim 1, wherein said optical position sensor comprises an optical camera unit adapted to provide image data of successive images of a surface of the test specimen.

6. The eddy current testing apparatus according to claim 5, wherein said optical position sensor further comprises or is further connected to a digital signal processor that is connected to said camera unit so as to receive said image data, and that is adapted to process said image data to provide said position data responsive thereto.

7. The eddy current testing apparatus according to claim 6, wherein said digital signal processor is adapted to process said image data so as to determine a displacement direction and a displacement distance of said moveable unit being moved relative to the test specimen based on differences among said successive images as determined by a comparison of said image data respectively of said successive images, and is adapted to provide said position data including said displacement direction and said displacement distance.

8. The eddy current testing apparatus according to claim 6, wherein said digital signal processor is adapted to process said image data so as to determine a first displacement distance in an X-direction and a second displacement distance in a Y-direction of said movable unit being moved relative to the test specimen based on differences among said successive images as determined by a comparison of said image data respectively of said successive images, and is adapted to provide said position data including said first displacement distance and said second displacement distance.

9. The eddy current testing apparatus according to claim 0.5, wherein said optical camera unit comprises a light emitting diode arranged and adapted to emit light onto the surface of the test specimen, and an optical detector arranged and adapted to detect said successive images of the surface of the test specimen illuminated by said light and to provide said image data.

10. The eddy current testing apparatus according to claim 9, wherein said optical detector comprises a CMOS optical sensor.

11. The eddy current testing apparatus according to claim 5, wherein said optical camera unit has an optical resolution of at least 800 dpi or 0.03 mm.

12. The eddy current testing apparatus according to claim 1, wherein said optical position sensor comprises the same components and the same construction and the same operation as an optical position sensor used in an optical computer mouse.

13. The eddy current testing apparatus according to claim 1, excluding a mechanical scanner arrangement connected to said testing head.
